(19) United States
(12) Patent Application Publication
(10) Pub. No.: US 2003/0084993 A1
(43) Pub. Date: May 8, 2003

(54) Methods and apparatus to bind coated sheets of media

(76) Inventor: Roland Boss, Jalisco (MX)

Correspondence Address: HEWLETT-PACKARD COMPANY, Intellectual Property Administration, P.O. Box 272400, Fort Collins, CO, 80527-2400, US

(21) Appl. No.: 10/001,297

(22) Filed: Nov. 2, 2001

(51) Int. Cl. B32B 31/00

(52) U.S. Cl. 156/275.1; 156/308.4; 156/379.8

(57) ABSTRACT

A method of binding a plurality of sheets into a bound sheet stack. The method includes providing a first sheet and a second sheet. At least one of the sheets has a protective coating applied to a least a portion of the sheet. The first and second sheets are overlaid so that at least a portion of the protective coating on one of the sheets contacts the other sheet. A binding energy is then applied to a binding region on the first and second sheets to thereby bind the sheets into a sheet stack. The binding region includes at least a portion of the protective coating on at least one of the sheets, and which is in contact with the other sheet.

### FIELD OF THE INVENTION

The invention claimed and disclosed herein pertains to binding together sheets of media which have previously been coated with a protective coating, to thereby produce a booklet or the like.

### BACKGROUND OF THE INVENTION

Currently used methods to bind multiple sheets of media together include stapling, clamping, gluing and/or sewing (stitching) the sheets to one another. The sheets of media typically are made from paper or a paper-based material. For example, the sheets of media can include common photocopier paper (such as a 20-weight wood pulp based paper), cardstock, cotton-based paper, photographic paper (which has a coating on a base paper foundation), and paper including a polymer component to strengthen the paper.

Many of the prior-art methods of binding sheets, such as stapling and sewing, are destructive in that they require the media to be pierced in order to join one sheet to another. This is undesirable since, if the bound sheets are later separated, the individual sheets will then have holes in them. Further, almost all of the prior art sheet binding methods produce a sheet stack that has one edge or corner which is thicker than the rest of the sheet stack as a result of the addition of the material used to bind the sheets to one another. In addition, many of the prior art binding methods introduce a tertiary component to the bound sheet stack which can be undesirable if the sheet stack is later to be recycled. For example, a metal staple is typically not recyclable using traditional paper recycling methods, and so the staple must either be removed prior to recycling the sheet stack, or the recycling process must be configured to address the presence of the staple.

It is also known to laminate a sheet of imaged media using a protective coating such as an acrylic resin or a polymeric based film. These coatings serve to protect the sheet against mechanical damage, and also preserve the sheet, and the image affixed thereto, against the effects of aging. The process of applying the protective coating can be performed within an imaging device which is used to create the imaged sheet of media. Alternately, the protective coating can be applied by an apparatus separate from the imaging apparatus. Typically, after the image has been applied to the sheet of media and fixed thereto by a process such as fusing, drying or chemical transformation, the protective coating is applied to one side (or both sides) of the sheet. The protective coating is then to secured to the sheet, using a process such as the application of energy (for example, in the form of heat and/or pressure), or by a chemical adhesion process (e.g., using a glue), or a combination thereof. The protective coating can be impregnated with additives such as UV filters and the like to further protect the image and the underlying sheet itself. The coatings can be configured to have a selected appearance, such as a matt finish or a gloss finish. Further, the coatings can be a clear or a colored (tinted) transparent coating, or (less commonly) a translucent coating.

When such laminated sheets are bound to one another using the intrusive methods of the prior art (stapling and stitching, for example) the protective coating must necessarily be pierced. This piercing forms holes in the coating and the underlying sheet, thus presenting a point of entry for elements (such as air and moisture) to deteriorate the sheet, thereby defeating one of the fundamental purposes of the coating. Further, if the sheets are later unbound, then these holes will be visible, thereby reducing the visual appeal of the sheet. The use of non-intrusive binding methods (such as gluing) for such laminated sheets still presents the problems of the sheet stack having one edge or corner which is thicker than the rest of the sheet stack. In addition, the glue can have an adverse chemical effect on the coating, and can also present an unappealing visual presentation if the sheets are later unbound.

Yet another method of binding together sheets of media is disclosed in my co-pending U.S. patent application Ser. No. 09/320,060, filed May 26, 1999, Ser. No. 09/482,124, filed Jan. 11, 2000, and Ser. No. 09/880,544, filed Jun. 12, 2001, and which is a divisional of Ser. No. 09/482,124, all of which are incorporated herein by reference. One of the methods disclosed therein for binding sheets of media to one another is to use a toner material applied by an imaging apparatus to a binding region, and then applying energy to the toner applied to one sheet to cause it to fuse to an adjacent sheet, thereby binding the two sheets together. However, as with using glue or the like to bind sheets, this results in a generally thicker section of the document in the binding region. However, more importantly, due to the inherent limitations of imaging devices, toner can generally be applied no closer than about 5 mm from the edge of a sheet of media. The result is that a bound document using toner as the binding medium will not have what is known as a “full-bleed” binding. That is, the sheets of the document will not be bound at the edges, but slightly inward of the edge. This results in a document which can become prematurely shop-worn along the edge next to the binding region, presenting an unpleasant visual appearance to the document.

What is needed then is a method of binding imaged sheets of media, and particularly laminated imaged sheets, which achieves the benefits to be derived from similar prior art methods, but which avoids the shortcomings and detriments individually associated therewith.

### SUMMARY OF THE INVENTION

The present invention provides methods and apparatus for binding together sheets of media using a protective coating. One embodiment of the present invention provides for a method of binding a plurality of sheets into a bound sheet stack. The method includes providing a first and a second sheet. At least one of the sheets has a protective coating applied to at least a portion of the sheet. The method further includes overlaying the sheets so that at least a portion of the protective coating of one sheet is in contact with the other sheet. The method then includes and applying a binding energy to a preselected area (a binding region) of the first and second sheets to thereby bind the sheets into a sheet stack. The binding region includes at least a portion of the protective coating. The binding energy can comprise at least one of heat, pressure or ultrasonic energy, as well as other forms of energy.

A second embodiment of the present invention provides for an apparatus for forming a bound document from a plurality of sheets. The apparatus includes an imaging section configured to generate images on sheets of media, and a coating section configured to apply a protective coating to an imaged sheet of media. The apparatus further includes a holding device and a binding device. The holding device is configured to receive and hold a plurality of sheets of media. The binding device is configured to apply a binding energy to a portion of the protective coating on at least one of the plurality of sheets of media in the holding device and thereby bind the sheets in the holding device to one another.

These and other aspects and embodiments of the present invention will now be described in detail with reference to the accompanying drawings, wherein:

### DESCRIPTION OF THE DRAWINGS

FIG. 1A is a plan view depicting multiple media sheets having a protective coating that can be bound into a document, showing the binding region along the left edge of each sheet.

FIG. 1B is a partial side elevation sectional view of one sheet of the sheets of media depicted in FIG. 1A.

FIG. 2 is an isometric view depicting sheets being bound into a document showing a single sheet positioned over a stack of sheets that have already been, or will be, bound together.

FIG. 3 is an isometric view depicting a binding device constructed according to one embodiment of the present invention in which the document is stacked horizontally and the binding device uses a thermally dissipative heat sink.

FIGS. 4A-4C depict sequential cross sectional views of the binding device of FIG. 3 showing an individual media sheet having a protective coating being bound to a previously bound stack of sheets.

FIGS. 5A-5C depict sequential cross sectional views of a binding device constructed according to a second embodiment of the present invention in which the document is stacked horizontally and the binding device uses an electrically dissipative heat sink.

FIG. 6 is a plan view of a sheet of media having a protective coating showing various locations at which the sheet can be bound to other sheets using the methods and apparatus of the present invention.

FIG. 7 is an isometric view of two sheets of media having protective coatings which are folded prior to being bound together by the methods and apparatus of the present invention.

FIG. 8 is a side elevation schematic diagram depicting an imaging device in accordance with the present invention, and which can bind sheets of media having protective coatings, in accordance with the methods of the present invention.

FIGS. 9A and 9B depict a partial side elevation sectional view of sheets of media having protective coatings, and showing how the sheets can be bound to one another in accordance with variations on the methods of the present invention.

FIG. 10 is a side elevation view of a variation on the apparatus depicted in FIGS. 4A-4C, showing how the sheets of media having protective coatings can be bound along the edges of the sheets.

FIG. 11 depicts an isometric view of a single sheet pamphlet which can be bound along the edge using the methods of the present invention.

### DETAILED DESCRIPTION OF THE INVENTION

The present invention provides methods and apparatus for binding together sheets of media which have a protective coating applied thereto. Generally, the invention comprises applying a binding energy to a binding region (i.e., a preselected location on the sheets where they are to be bound together) of at least one coated sheet to cause the protective coating to transform to a state where it can bond to another sheet placed over the at-least-one coated sheet. The binding energy can be in a number of different forms. In one example the binding energy is applied in the form of a combination of heat and pressure. In this way sheets with protective coatings can be bound together without the use of intrusive binding means (e.g., staples, stitching, etc.), and without the introduction of a tertiary binding material (such as glue) which can create a bound document of an uneven thickness.

The protective coating can be applied to all, or only part of, a side of a sheet of media, or it can be applied to both sides of the sheet of media. The protective coating can be, for example, a plastic, such as a polymer, or a resin. The coating can be applied using known methods for applying protective coatings to sheets of media. Such methods are disclosed, for example, in U.S. Pat. Nos. 6,042,675, 5,807,461, and 5,961,779, all of which are incorporated herein by reference in their entirety. An example of a protective coating which can be used in the present invention is described in U.S. Pat. No. 5,681,660, incorporated herein by reference in its entirety.

Preferably, in the methods of the present invention, two sheets of media (at least one of which has a protective coating applied thereto) are stacked on top of each other. The sheets are stacked so that at least a portion of the protective coating on one sheet contacts the other sheet. Preferably, the sheets are stacked in alignment along a common edge, although this is not a requirement. Thereafter, a binding energy is applied to a preselected area (the binding region) of the first and second sheets to thereby bind the sheets into a sheet stack. The binding region includes at least a portion of the protective coating on the one sheet which is in contact with the other sheet. The binding energy is selected to reactivate the protective coating. That is, the binding energy is selected to cause the protective coating on at least one sheet to transform to a state (such as a plastic state, a near-liquid state or a liquid state) where it will adhere or fuse to a facing sheet. The side of the facing sheet to which the protective coating is fused can be an uncoated side of a sheet, or a side of a sheet which also has a protective coating applied thereto. Examples of binding energy which can be used include, but are not limited to, heat, pressure or ultrasonic energy. In one variation the binding energy is selected to cause the protective coating, which applied to a first sheet to, substantially fuse to the second sheet in the binding region. This results in an essentially permanent bond between the two sheets, similar to the bond between the protective coating and the sheet to which the protective coating is initially applied. In another variation the binding energy is selected to cause the protective coating on the first sheet to partially fuse to the second sheet in the binding region. This results in a weaker bond between the two sheets, allowing the two sheets to be later pulled apart without pulling the protective coating off of the sheet to which the coating is initially applied.

The methods and apparatus of the present invention can be used to bind a stack or two or more sheets together. When more than two sheets are bound together, the binding energy can be applied either to the entire stack of sheets in a single application, or to individual sheets (or multiples of sheets) as they are added to the stack. That is, when more than two sheets are to be bound together using the methods of the present invention, all of the sheets can first be laid onto one another, and the binding energy then applied to the entire stack of sheets. Alternately, each sheet can be bound to the previous sheet in the accumulating sheet stack (i.e., a “sub-stack”) one at a time. Further, a plurality of sheets can be bound to the last-bound sheet in the accumulating sheet stack. For example, two sheets can be bound together. Then two more sheets can be laid onto the first two bound sheets, and the latter two sheets then bound to the first two bound sheets.

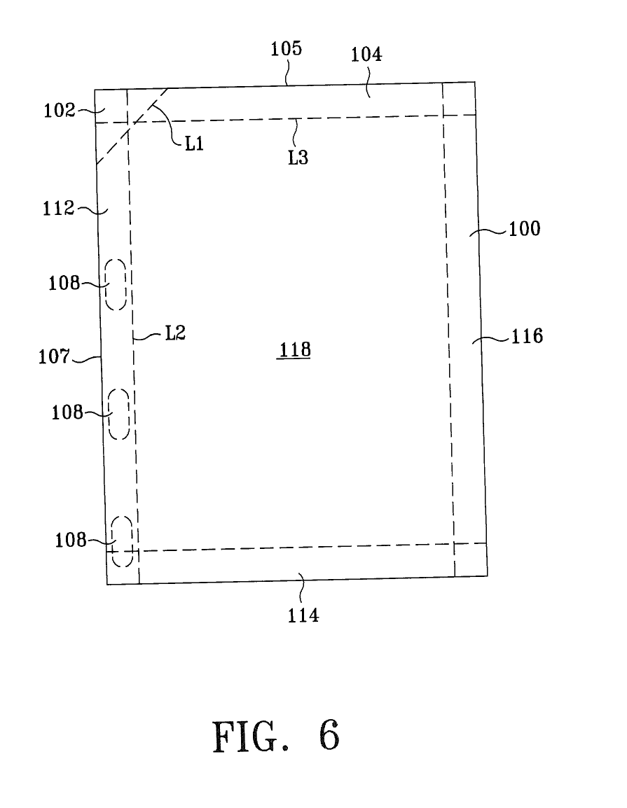

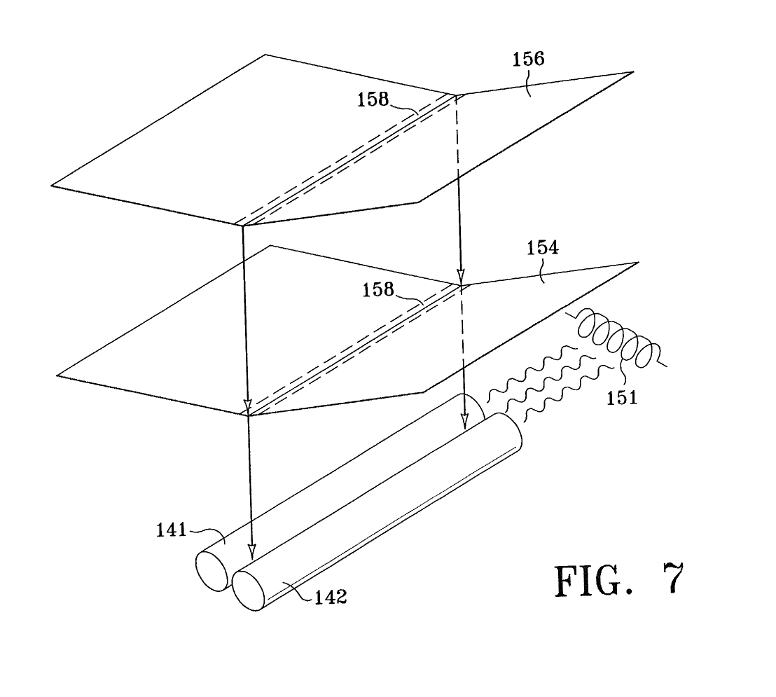

The binding region can be located in various positions on the sheet. For example, with respect to FIG. 6 which depicts a plan view of a sheet 100 to be bound to another sheet (not shown), the binding region can be the area 112 which extends inwardly from a common first edge 107 of the sheets to line L2 so that the sheets are substantially bound along an area which lies in the plane of the sheets. The sheets can also be bound at the top in binding region 104, defined by second edge 105 and line L3. The advantage of binding the sheets in the binding regions 112 and 104 using the methods of the present invention is that it provides a “full-bleed” binding. That is, the sheets are bound along a continuous area with (essentially) no gaps in the binding area, and the binding can be fully extended to the edge of (and can include the edge of) the sheets of media which make up the bound document. This produces a strong binding, and an even, pleasant appearance. The binding region can also extend along the first edge 107 of the sheets so that the sheets are essentially bound only along their edges. The advantage of this binding along an edge is that it allows the sheets to be easily separated at a later time, with little disfiguring of the protective coating or the sheet itself. The binding region can also be located at a common corner (or corners) 102 (defined by line L1) of each sheet. This type of corner binding provides a more secure binding than binding along the edge 107 only, but also allows the sheets to be later separated more easily than if the sheets are bound in the region 112 or 104. The binding region does not need to be continuous. For example, the binding region can be localized regions 108 along the left side 107 of the sheet 100. In general, the binding region can any other location where the protective coating is applied to at least one of the sheets so that the protective coating can be used to bind the sheet to another sheet.

In one variation, prior to applying the binding energy, a first sheet can be folded to thereby create a first sheet folded edge. A second sheet can also be folded to thereby create a second sheet folded edge. The binding region can then extend along the folded edges of the sheets. The folded sheets can first be interleaved prior to applying the binding energy. This is demonstrated in FIG. 7, which depicts, in an isometric diagram, a second sheet 156 being bound to a first sheet 154 in a binding region 158, along which the sheets are each creased. In the example shown, the sheets are first stacked one on top of the other, and then folded along crease 158. Binding energy in the form of heat and pressure are then applied to the binding region 158 by respective heating element 151 and rollers 141 and 142. Alternately, the folded sheets can be stacked on top on one another and then the binding energy applied to the binding region. Or, the sheets can both be first individually folded, then interleaved, and the binding energy then applied. However, where the sheets of media are relatively thick, as will generally be the case with sheets of media having a protective coating applied thereto, interleaving will tend to result in the free edges (i.e., the edges opposite the bound edges) of the inner sheets protruding slightly beyond the free edges of the outer sheets. This can produce an unpleasant visual appearance to the bound document, and so it can be desirable to trim the free edges to a common aligned edge after interleaving and binding the sheets.

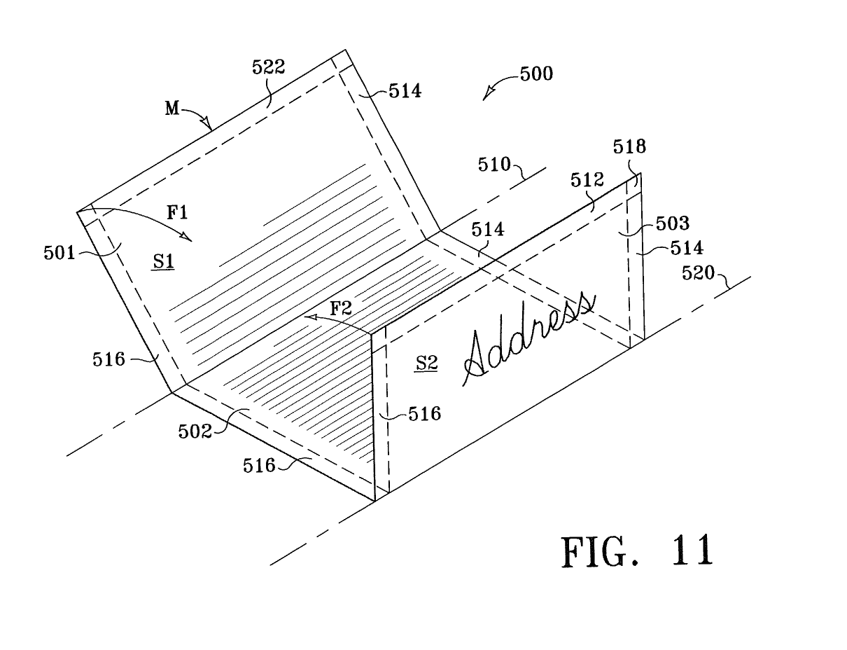

Yet another embodiment of the present invention does not include binding a first sheet to a second sheet, but rather includes binding a first portion of a sheet to a second portion of the same sheet. An example of this is depicted in FIG. 11 which shows a partially opened tri-fold pamphlet 500, such as might be used in a mass-mailing or the like. The pamphlet 500 is comprised of a sheet of media “M” having a protective coating (not visible in the figure) applied thereto. For purposes of illustration, let us assume that the protective coating is applied to a first side “S1” of the sheet 500, while the second side “S2” is uncoated. The sheet of media “M” will be folded along a first fold-line 510, which defines first pamphlet portion 501 and second (or central) pamphlet portion 502. Likewise, fold-line 520 defines third pamphlet portion 503. The folding can be performed using known apparatus for automatically folding a sheet of media along one, two, or more fold lines. Such folding apparatus can be incorporated into a sheet finishing apparatus, which can also include the sheet binding apparatus of the present invention. In order produce a final folded pamphlet from the sheet of media “M” depicted in FIG. 11, the first portion 501 of the sheet 500 will be folded in direction “F1” onto the central portion 502. Next, the third portion 503 will be folded in direction “F2” over the (previously folded) first portion 501. In the resulting folded pamphlet, when only the side “S1” has a protective coating, the outward surface of the pamphlet (i.e., the portions of the pamphlet visible to a person viewing the folded pamphlet) will be uncoated. This allows a mailing address and postage to be applied more easily to the pamphlet for mailing and the like.

A number of different variations of sheet binding can be used in this situation after the sheet “M” of FIG. 11 is folded into its final shape, to thereby seal the portions of the pamphlet 500 to form a sealed pamphlet. In one example, the pamphlet 500 of FIG. 11 can be loosely bound in a closed position by applying a binding energy to the corners 518 of the third portion 503 to bind it to the first portion 501, which has been previously folded over the central portion 502. The binding energy will cause the protective coating on the first side “S1” of third portion 503 to bind to the uncoated side “S2” of the first portion 501. In another example, after portions 501 and 503 are folded as described above, binding energy can be applied along the binding region 512 along the top edge of the pamphlet portion 503 to provide a sealing along one entire edge, thus leaving only the side edges (regions 514 and 516) unsealed. Furthermore, binding energy can be applied to binding regions 514 and 516 after the pamphlet has been folded to seal all 3 of the sealable edges. In this last example, prior to folding the third portion 503 of the pamphlet 500 onto the first portion, 501, the first portion 501 can be sealed to the second portion 502, and thereafter the third portion 503 can be sealed to the first portion 501. A benefit of applying a seal around all three free edges of the pamphlet 500 is that a relatively tamper-evident pamphlet is produced, since breaking the binding seal will generally leave a mark on the side “S1” of the pamphlet along at least a portion of the binding region (512, 514, 516). As is evident, a similar method can be used to produce a bi-fold pamphlet (as for example, of portions 501 and 502 only), which can be sealed along the sides (514, 516), as well as along the bottom (522).

In a similar manner, two separate sheets can be bound together along more than one edge. Returning to FIG. 6, two sheets (each as sheet 100) can be bound along any combination of the binding regions 104, 112, 114, and 116 using the methods of the present invention. For example, by binding the sheets 100 along binding regions 104, 112 and 114, an envelope can be formed, allowing a free sheet of media (of smaller dimension than sheet 100) to be inserted into the resulting envelope. The envelope can be later sealed by binding the sheets 100 together along binding region 116. Further, the sheets can be fully bound to one another across their entire surface 118. Accordingly, the methods of the present invention can be used to create a seal by binding two sheets, or two parts of a single sheet, together.

The present invention also provides for a method of producing a bound document. The method includes providing a first sheet and a second sheet of media on which an image can be generated. An image is then generated on at least one of the sheets of media, and can include text and/or images. A protective coating is applied to at least one of the sheets of media, and the sheets are then overlaid so that at least a portion of the protective coating is in contact with at least a portion of the other sheet. Thereafter a binding energy is applied to a preselected binding region, in the manner described above, to cause the protective coating on one sheet to adhere to a second sheet. The method can be extended to include additional sheets, also as described by the method described above. This method of the invention can be implemented using an imaging apparatus (such as a photocopier) which is configured to generate images on sheets of media and apply a protective coating to the imaged sheets. The apparatus can include an integral binding device (which I will describe further below), or the binding device can be a separate unit such that, after the sheets are imaged and coated, they are then moved to the binding device to be bound together, in accordance with the method of the invention. Further, the imaging of the sheets of media and the application of the protective coating to the sheets can be performed by separate apparatus.

As is evident by the above discussion, it is not a requirement that all sheets in the bound document have protective coatings applied to them. For example, an uncoated first sheet can be bound to a coated second sheet so long as the uncoated first sheet contacts at least a portion of the coating on the second sheet. Further, if a first sheet has a coating applied to both sides of the sheet, then the coated sheet can be bound between two uncoated sheets. Generally, however, it is anticipated that each sheet of the document will have a protective coating applied to at least one side of the sheet.

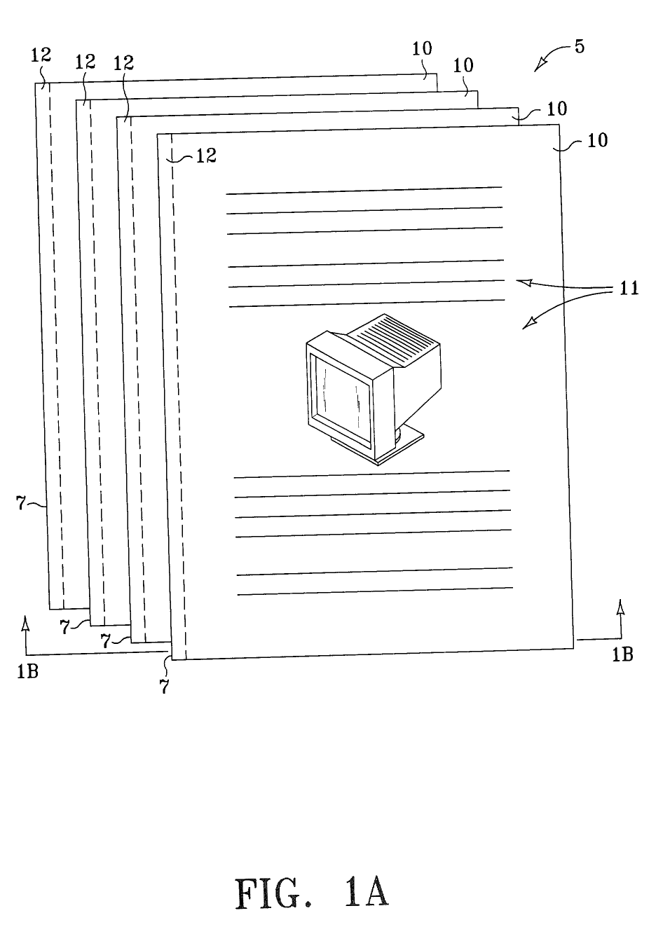

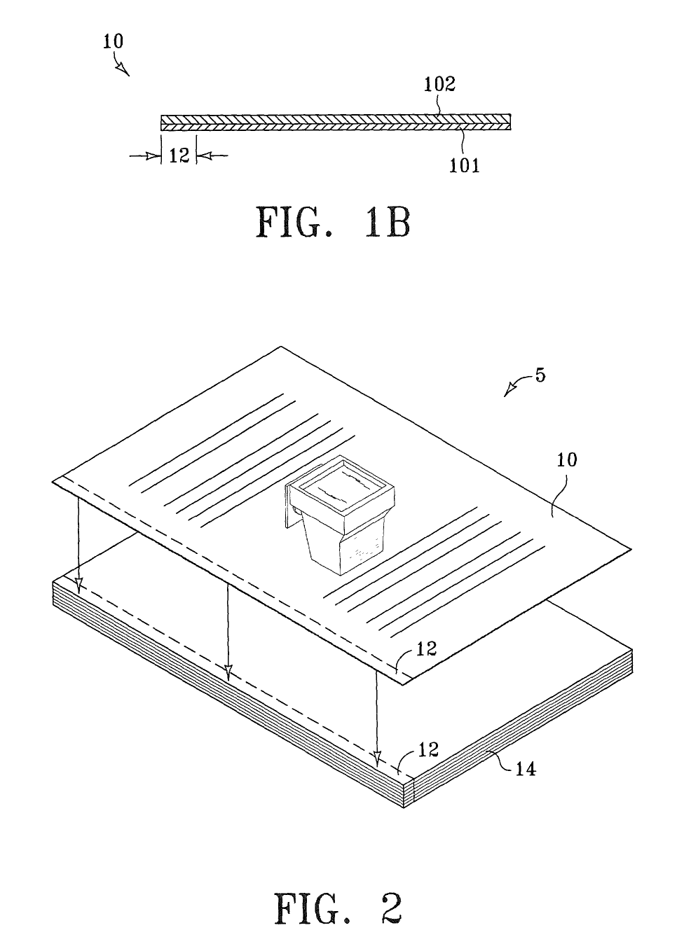

I will now describe specific, non-limiting, examples of the methods and apparatus of the present invention. With respect to FIG. 1B, a document 5 comprised of 4 sheets 10 is to be bound together into a bound document. The sheets 10 can have an image generated thereon, such as text or graphics 11. The image can be applied to one or both sides of the sheets. In this example the sheets 10 are to be bound along the binding region 12 which extends inwardly from a first edge 7 of each sheet. For the purpose of this example, assume that each sheet 10 is provided with a protective coating. FIG. 1B depicts a side elevation view of a sheet 10. The sheet 10 has an underlying media sheet 101, which can be, for example, paper or cardstock or photographic paper. Applied to the media sheet is a protective coating 102, which can be, for example, a resin based or a polymeric based coating. FIG. 2 depicts how a sheet 10 is being applied to a sub-stack of sheets 14 to thereby create the bound document 5. In FIG. 2, the sub-stack 14 can be previously bound along the binding region 12, or the entire stack of sheets 5 can be bound after all of the sheets have been stacked. Alternately, the sheets 10 (FIG. 1A) can be bound in multiples (e.g., in twos, threes, etc.) to the sub-stack 14.

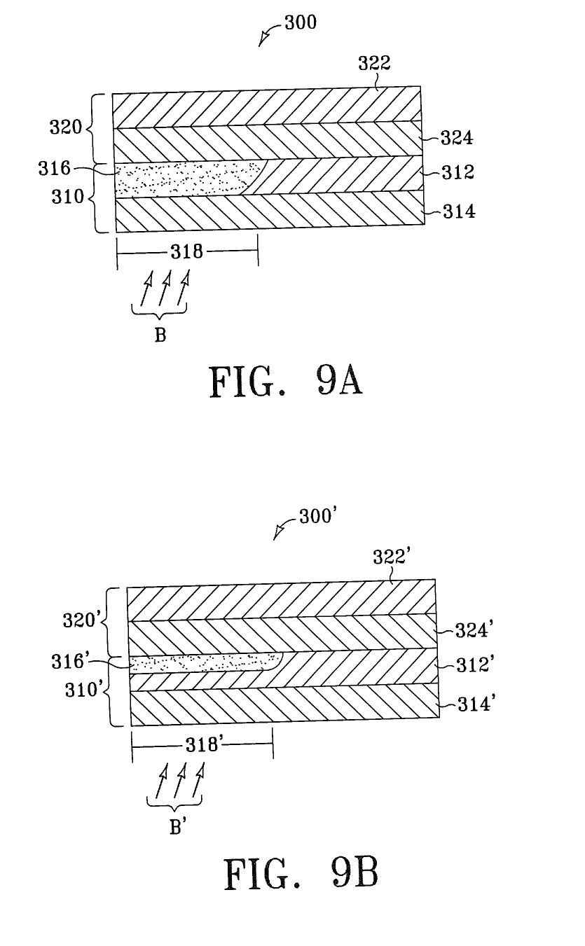

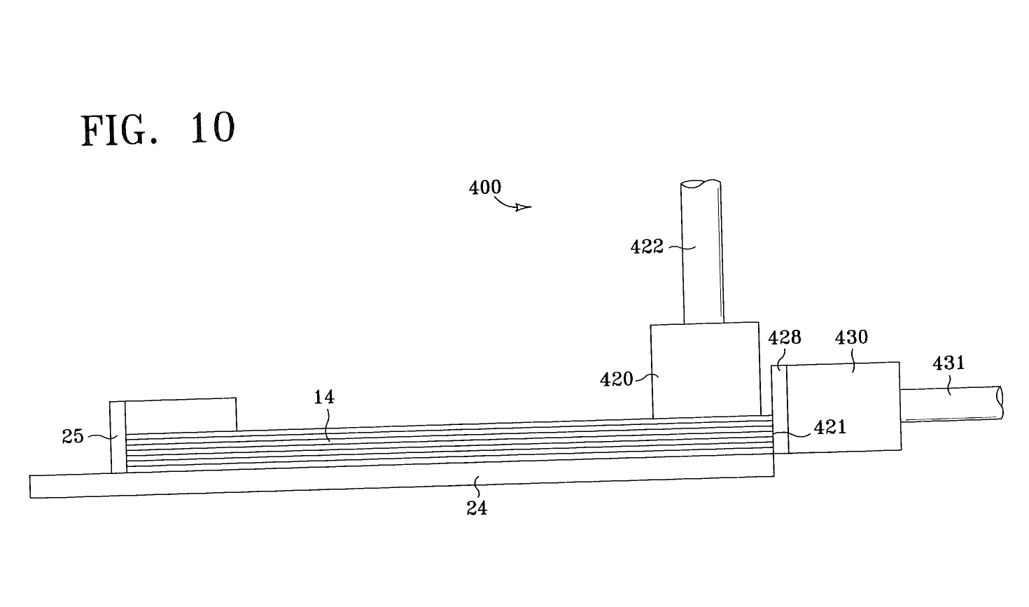

In order to bind one sheet to another, a binding energy is applied to a sheet having a protective coating applied thereto. The binding energy is preferably applied only to the binding region. The amount of binding energy applied to a sheet is selected to cause the protective coating in the binding region to be transformed to a state where the protective coating will bind or fuse with either (1) the protective coating on another sheet, or (2) to the underlying media sheet of another sheet. For example, with respect to FIG. 9A, a cross sectional diagram of a second sheet 320 being bound to a first sheet 310 is depicted. First sheet 310 has a protective coating 312 applied to a media sheet 314, and second sheet 320 has a protective coating 322 applied to a media sheet 324. Sheets 310 and 320 are to be bound along a binding region 318. Binding energy “B” is applied in the direction of the media sheet 314 of the first sheet to cause the protective coating 312 to transform to a non-solid state, and thereby bind to the lower surface of the media sheet 324 of the second sheet 320. As can be seen, the protective coating 312 in the binding region 318 has been transformed through essentially the entire thickness of the coating 312 in the binding region 318. FIG. 9A is to be compared with the cross sectional diagram of FIG. 9B, wherein the second sheet 320′ is being bound to first sheet 310′ by binding energy B′. As can be seen, the protective coating 312′ of the first sheet 310 is only partially transformed to a non-solid state in the binding region 318′. Accordingly, the bond to the media sheet 324′ of the second sheet 320 will be less strong than the bond formed between the sheets 310 and 320 in FIG. 9A. The amount of the protective coating affected by the binding energy, and thus the strength of the bond between the sheets, can thus be selectively varied based on the intensity of the binding energy applied in the binding region, as well as the period of time over which the binding energy is applied.

Examples of binding energy which can be used to effect the above-described binding process can include, but are not limited to, heat, pressure, ultrasound, magnetic energy, radio frequency energy and other forms of electromagnetic energy, or any combination thereof. Preferably, a combination of heat and pressure is used as the binding energy.

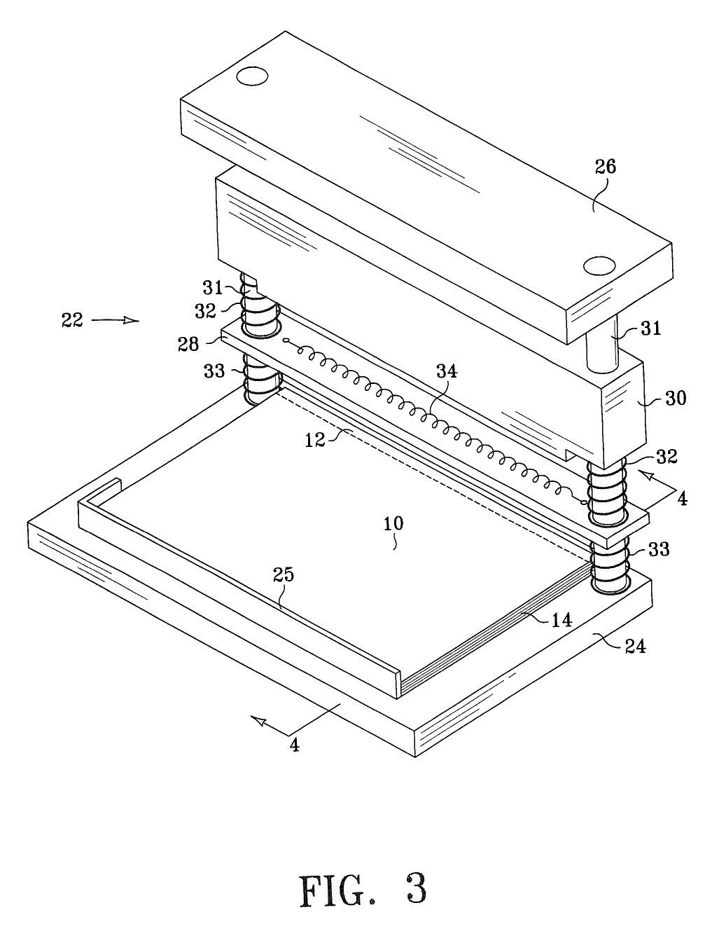

Turning now to FIG. 3, a binding device 22 which can be used to implement the sheet binding methods of the present invention is depicted in an isometric view. The binding device 22 is but one example of a binding device which can be used to implement the methods of the present invention. Referring to FIG. 3, binding device 22 includes a sheet collecting tray or holding device 24, press 26, heating member 28 and heat sink 30. Press 26, heating member 28 and heat sink 30 move up and down or back and forth along guide posts 31. Heating member 28 is biased away from the sheet collection area of tray 24 with, for example, compression springs 32 to provide adequate clearance for the document. Press 26 is operatively coupled to heating member 28 through heat sink 30 and a second pair of compression springs 33 positioned between heat sink 30 and heating member 28. Preferably, heat sink 30 will have a much greater effective thermal mass than heating member 28 and heating member 28 will be very thin to promote rapid heating and cooling. In this embodiment, heating member 28 includes an electrically resistive heating element 34. Heating member 28 is heated, for example, by electric current passing through a resistive element 34. The relatively large thermal mass of heat sink 30 can be achieved in a variety of ways. For example, heat can be dissipated passively through a large physical mass of thermally conductive material that dissipates heat by thermal conduction as it contacts heating member 28. Heat can also be dissipated actively through a convection heat sink in which moving air is used to cool heating member 28. Or, heat can be dissipated through a material having a much lower electrical resistance that diverts electrical current from heating member 28. A combination of two more of these techniques can also be used. The relationship of the heat capacities of heating member 28 and heat sink 30 can be optimized for the particular operating environment to help facilitate continuous operation of binder 22.

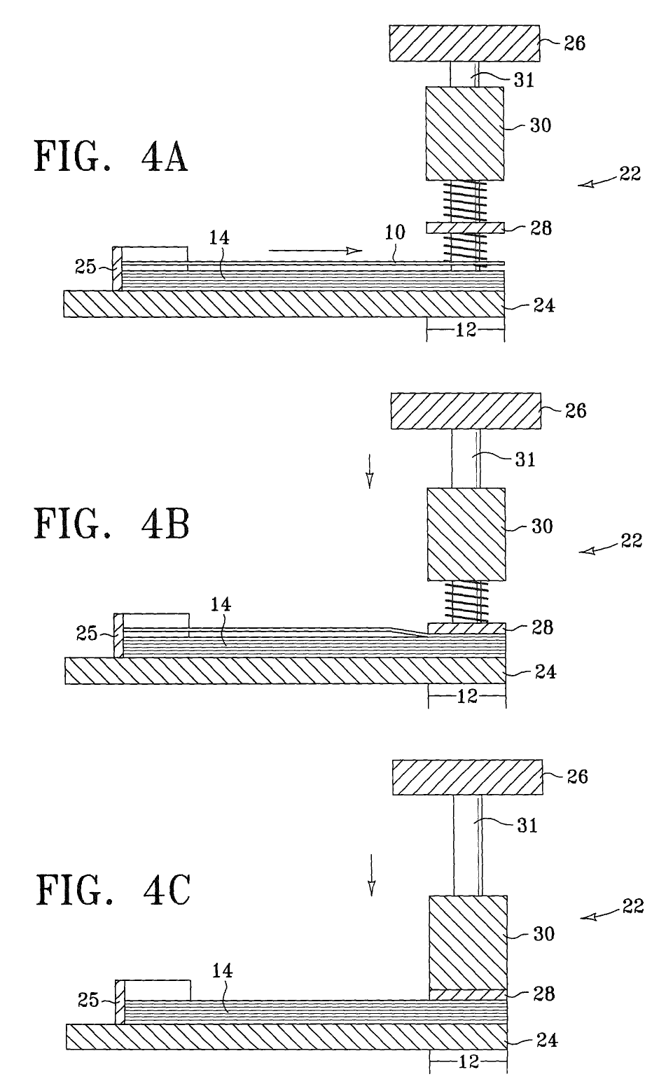

The operation of the binding device 22 will now be described with reference to the section view of binding device 22 in FIGS. 4A-4C. Each sheet 10 is placed into the holding device (tray) 24 (FIG. 3). In the example shown, it is assumed that the sheets have a protective coating applied onto to the side of the sheet bearing the image, as depicted in FIGS. 1A and 1B. Thus, the sheets are placed in the tray 24 in a “face down” position so that the protective coating does not directly contact the heating member 28. Sheet 10 is aligned to the stack 14 as may be necessary or desirable using conventional techniques, such as edge guide 25. As press 26 descends against heat sink 30 (FIG. 4A), it overcomes the resistance of first biasing springs 32 and presses heating member 28 against top sheet 10 and stack 14 along binding region 12 (FIG. 4B). The heat and pressure (binding energy) applied to binding region 12 of sheet 10 reactivates (melts or softens) the protective coating material in region 12 so that it can bind to the uppermost sheet in the stack 14. As press 26 continues to descend, it overcomes the resistance of second biasing springs 33 and presses heat sink 30 into contact with heating member 28, as seen by comparing FIGS. 4B and 4C. The large comparatively cool thermal mass of heat sink 30 cools heating member 28, sheet 10 and stack 14. Press 26 is held momentarily in the fully descended position to maintain pressure on sheet 10 and stack 14 as the heating member 28 cools. The cooling combined with the continuing compression of sheet 10 and stack 14 allows the reactivated protective coating to cure, and thereby bind sheet 10 to the stack 14. As the pressure is released, biasing springs 32 and 33 return heating member 28 and heat sink 30 to their respective starting positions.

In the embodiment illustrated in FIGS. 3 and 4A-4C, heat sink 30 is preferably a highly thermally conductive material such as an aluminum block or a forced air convection type heat exchanger. Heat sink 30 is preferably large enough to dissipate heat from heating member 28 throughout the binding operation. Second springs 33 are preferably stiffer than first springs 32 so that as press 26 descends heating member 28 is pressed against the stack 14 before heat sink 30 is pressed against heating member 28.

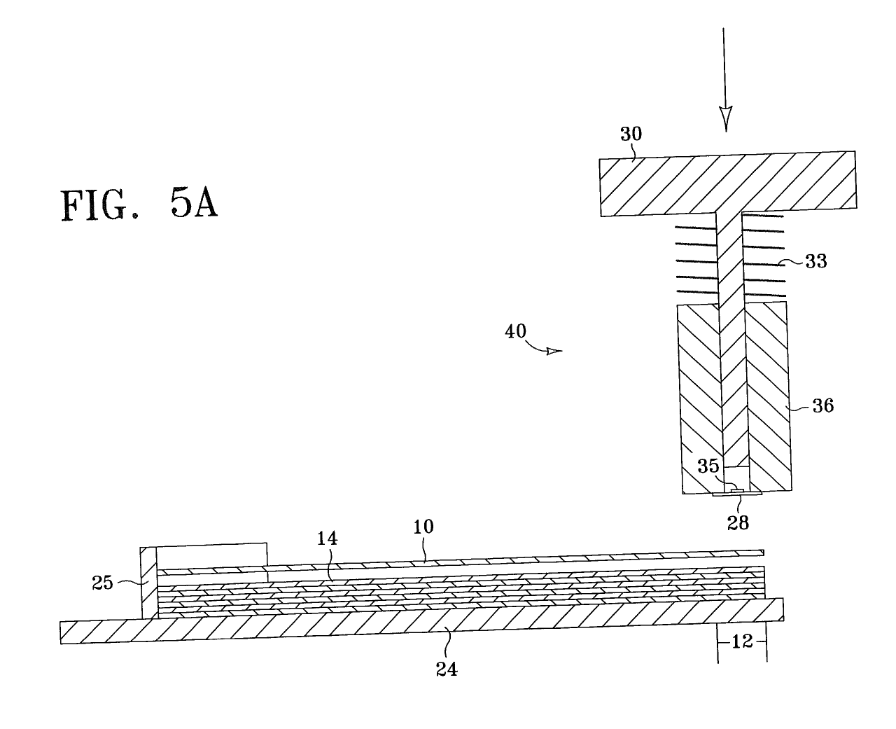

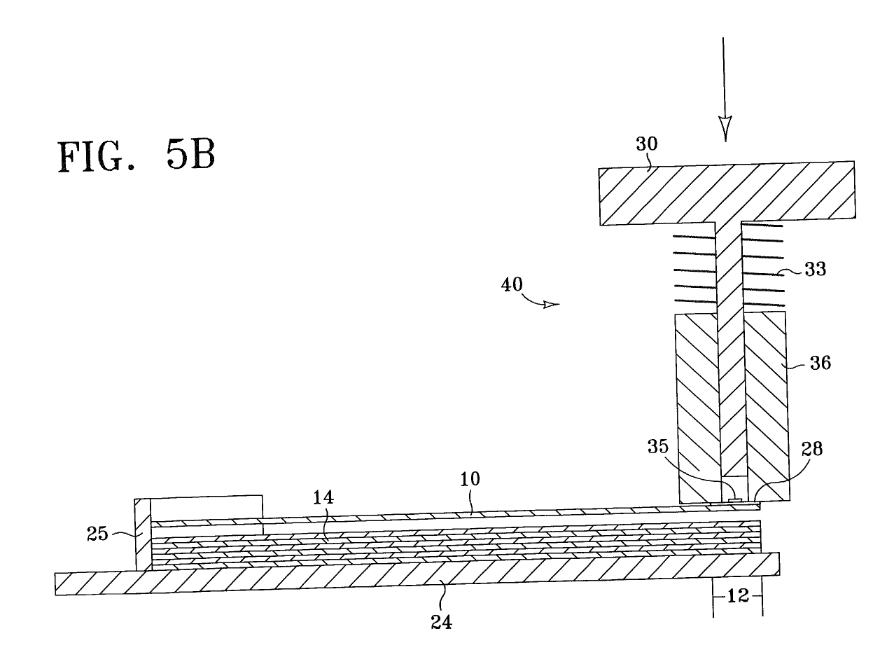

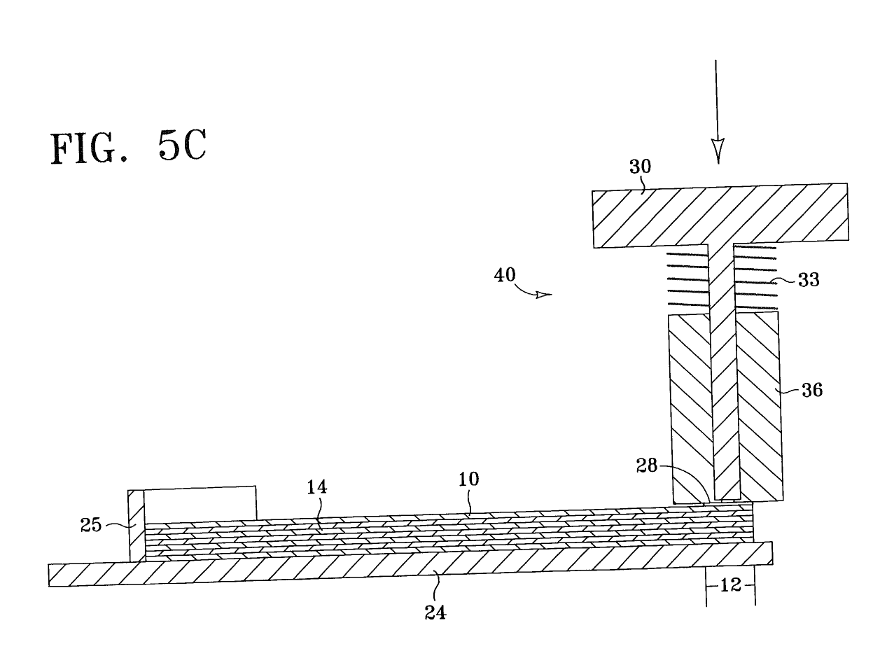

FIGS. 5A-5C illustrate an alternative embodiment of a binding device 40 in which an electrically dissipative heat sink 30 is used instead of the thermally dissipative heat sink of FIG. 3. Referring to FIGS. 5A-5C, sheets 10 accumulate in a tray 26, and are aligned by edge guide 25 (FIG. 5A). As heat sink 30 is pressed toward tray 24, heating member 28 is pressed into stack 14 at the urging of springs 33 and slide block 36 (FIG. 5B). As with the first embodiment, the heat and pressure (binding energy) applied to binding region 12 of sheet 10 reactivates the protective coating material in region 12. As heat sink 30 is pressed further towards tray 24, it overcomes the resistance of springs 33 and electrically contacts heating control circuit 35 (FIG. 5C). This electrical contact diverts or “short circuits” the electrical current from resistive heating element 34 in heating member 28 to the low resistance heat sink 30 to cool heating member 28. Again, as with the first embodiment, the binding device 22 is held momentarily in the fully compressed position (FIG. 5C) to maintain pressure on sheet 10 and stack 14 as the heating member 28 cools. The cooling combined with the continuing compression of media sheet 10 and stack 14 allows the reactivated protective coating material to cure, thus securing the uppermost sheet 10 to the sheet stack 14. Heat sink 30 and the other components are then withdrawn to their starting positions. An electrically dissipative heat sink can also be implemented through a switching circuit selectively connecting heating member 28 to a heat sink remote from binder 22. A remote electrically dissipative heat can be selectively connected to heating member 28 through control switching activated by temperature, sheet registration, timing or any other suitable control mechanism.

A variation on the binding device 40 of FIGS. 4A-4C is depicted in a side elevation sectional view in FIG. 10. The binding device 400 of FIG. 10 includes a holding device (tray) 24 and an edge guide 25 to hold the sheet stack 14 in place. The binding device uses a heating element 428 and a heat sink 430 which both move on guide post 431, similar to the operation of heating element 28, heat sink 30, and guide post 31 of FIG. 3. However, in FIG. 10 these components (the heating element, the heat sink and the guide post) are oriented at the edge of the sheet stack 14 so that the binding region 421 is along the edge of the stack. The heating element 428 and heat sink 430 are depicted in the fully depressed position and in contact with the document edge 421, similar to the position depicted in FIG. 4C. However, it is understood that the heating element 428 and heat sink 430 operably move from a position away from the document edge 421 to the position depicted in FIG. 10, similar to the way that heating element 28 and heat sink 30 move from the fully retracted position of FIG. 4A to the intermediate position of FIG. 4B, and finally to the fully depressed position of FIG. 4C. When the heating element 428 is in contact with the edge 421 of the sheet stack 421, the binding energy (here, heat) causes the protective coating at the edge of the sheets in the stack 14 to transform to a non-solid state so that the sheets are thus bound together along the edge 421 once the heating element is cooled and withdrawn.

The binding device 400 of FIG. 10 can includes an anvil 420, supported by shaft 422. The anvil 420 is operably moveable from a first position in which the anvil 420 is separated from the sheets 14 in the holding device 26, and a second position in which the anvil is urged against the sheets 14 near the edge 421 of the sheet stack. The anvil 420 thus holds the sheets stack 14 in a compressed, steady position while the heating element 428 and heat sink 430 are pressed against the edge 421 of the sheet stack 14. In this way all of the sheets in the stack 14 can be bound to one another by a single application of the heating element 421, whereas in the embodiments depicts in FIGS. 3 and 5A-5C the sheets are preferably bound either individually or in smaller units (e.g., 2 or 3 sheets at a time).

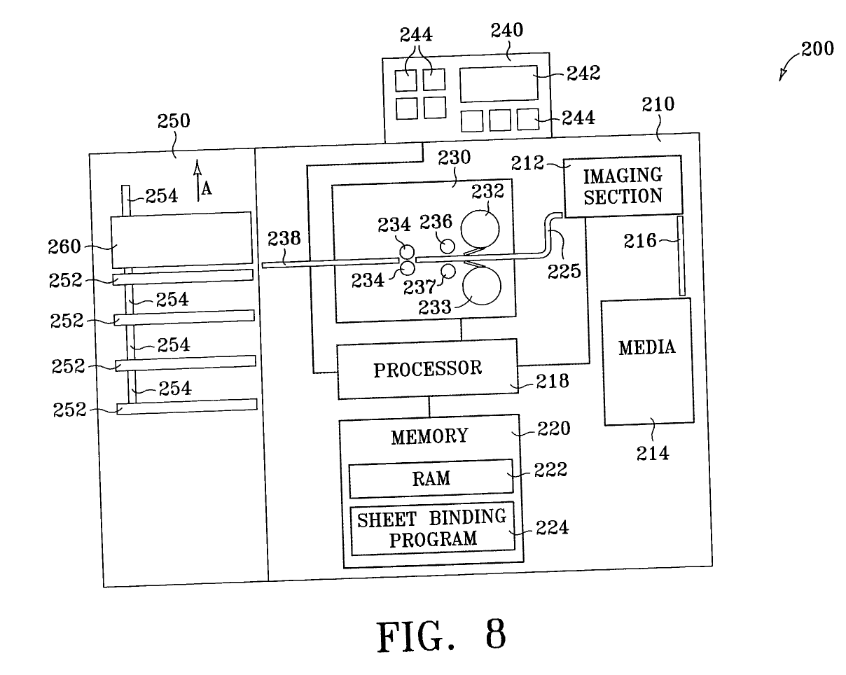

A third embodiment of the present invention provides for an apparatus for forming a bound document from a plurality of sheets. FIG. 8 depicts a side elevation schematic of such an apparatus. The apparatus can be, for example, a photocopier. The apparatus 200 of FIG. 8 includes an imaging portion 210 and a finishing portion 250. The imaging portion includes an imaging section 212 configured to generate images on sheets of media, such as paper and the like. The imaging section 212 can be, for example, an electrophotographic imaging section (i.e., a “laser printer”), a wet ink imaging section (such as an “inkjet” imaging section), or any other known types of imaging section. Media 214 moves along paper path 216 to the imaging section, where an image can be applied to the media. The imaging portion 210 of the apparatus 200 further includes a coating section 230 configured to apply a protective coating to an imaged sheet of media. The protective coating can be, for example, a polymeric material or an acrylic resin contained on a roll 232. Media from the imaging section 212 moves to the coating section 230 via guide 225. The protective coating can be applied from the roll 232 to the media, and the coated media is then moved by drive roller 236 into pressure rollers 234 (which can also apply heat to the media/coating combination) to thereby fix the coating to the sheet of media. The coated media is then moved along guide 238 to the finishing portion 250. A secondary roll of coating 233 and drive roller 237 can be also provided to apply a protective coating to a side of the sheet opposite from the side to which a protective coating will be applied by roll 232. In this way either or both sides of a sheet of media can have a protective coating applied thereto. It is understood that a sheet of media does not necessarily need to have an image applied to the sheet in the imaging section 212, and that a sheet of media does not necessarily need to have a coating applied to the sheet in the coating section 230. For example, if a sheet is to be left uncoated, then the sheet can either pass through the coating section 230 without having a coating applied to the sheet, or a bypass guide (not shown) can move the sheet around the coating section.

The imaging portion 210 of apparatus 200 can also include a processor 218 for controlling various operations of the apparatus. The processor can be in signal communication with a memory device 220 which can include a random access memory (“RAM”) component 222, which can be used to temporarily store images to be generated onto the media. The memory device 220 can also include a sheet binding program 224, which is a set of computer executable steps configured to be executed by the processor. The sheet binding program 224 can direct a binding device to bind the imaged, coated sheets to one another, in accordance with the methods described above. The imaging portion 210 of the apparatus 200 can also include a user console 240 having user input points (buttons or switches) 244 to allow a user to communicate instructions to the apparatus. The user console can also include a user display 242 to allow the processor 218 to communicate information to the user. The user console 240 can be used by a user to enable or disable the sheet binding program 224.

The finishing portion 250 of the apparatus 200 can include a binding device 260, which can operate according to any of the examples described above with respect to FIGS. 3, 4A-4C, 5A-5C and 10. That is, the binding device 260 applies a binding energy to two or more sheets, at least one of which has a protective coating applied thereto, to cause the sheets to be bound to one another via the protective coating. Preferably, the sheet binding device 260 is configured to move vertically on track 254 so that it can access document sheets placed in holding devices (trays) 252, and thus a plurality of copies of a single document can all be generated and bound during the same session.

While the above invention has been described in language more or less specific as to structural and methodical features, it is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

I claim:

1. A method of binding a plurality of sheets into a bound sheet stack, comprising:
providing a first sheet and a second sheet, at least one of the sheets having a protective coating applied to a least a portion thereof;
overlaying the first and second sheets so that at least a portion of the protective coating on the at least one sheet contacts the other sheet; and
applying a binding energy to a binding region defined on the first and second sheets to thereby bind the sheets into a sheet stack, the binding region comprising a selected area of the protective coating on the at least one sheet, the selected area being in contact with the other sheet.

2. The method of claim 1, and wherein the binding energy comprises at least one of heat, pressure, ultrasonic energy, or electromagnetic energy.

3. The method of claim 1, and wherein the binding energy comprises a combination of heat and pressure.

4. The method of claim 1, and wherein the binding energy is selected to cause the protective coating on the at least one sheet to substantially fuse to the other sheet in binding region.

5. The method of claim 1, and wherein the binding energy is selected to cause the protective coating on the at least one sheet to partially fuse to the other sheet in binding region.

6. The method of claim 1, and further comprising:
providing a third sheet which has a protective coating applied to at least a portion thereof;
laying the third sheet onto the sheet stack so that so that at least a portion of the protective coating on the third sheet contacts one of the first or the second sheet; and
applying the binding energy to the binding region to thereby bind the third sheet to the sheet stack.

7. The method of claim 1, and wherein the first and second sheets are each defined by a first edge, and when the sheets are overlaid, the first edges of the sheets substantially coincide, and further wherein the binding region extends inwardly from the first edge of the sheets.

8. The method of claim 1, and wherein:
the sheets are each further defined by a first corner;
when the sheets are overlaid, the respective first corners substantially coincide; and
the binding region is located at the first corner of the sheets.

9. The method of claim 1, and further comprising, prior to applying the binding energy, folding the first sheet to thereby create a first sheet folded edge, and folding the second sheet to thereby create a second sheet folded edge, and wherein the binding region extends along the folded edges of the sheets.

10. A method of producing a bound document, comprising:
providing a first sheet of media;
providing a second sheet of media;
generating an image on the second sheet of media;
applying a protective coating to the second sheet of media;
laying the second sheet onto the first sheet so at least a portion of the protective coating on the second sheet contacts the first sheet; and
applying a binding energy to a preselected binding region of the first and second sheets to thereby bind the sheets into a sheet stack.

11. The method of claim 10, and wherein the binding energy is applied in the form of at least one of heat, pressure or ultrasonic energy.

12. The method of claim 10, and wherein the first and second sheets of media are each defined by a respective first edge, and when the second sheet is laid onto the first sheet, the respective first edges of the sheets substantially coincide.

13. The method of claim 12, and further comprising:
providing a third sheet of media which is defined by a first edge;
generating an image on the third sheet of media;
applying a protective coating to the third first sheet of media;
laying the third sheet onto the second sheet so at least a portion of the protective coating on the third sheet contacts the second sheet and so that the respective first edges of the sheets substantially coincide; and
applying the binding energy to the preselected binding area to thereby bind the third sheet into the sheet stack.

14. The method of claim 13, and wherein the binding energy is first applied to the first and second sheets to form a sheet sub-stack, and the binding energy is then applied to the third sheet and the sheet sub-stack to form the sheet stack.

15. The method of claim 13, and wherein the binding energy is applied to the first, the second and the third sheets simultaneously to form the sheet stack.

16. The method of claim 10, and wherein the binding energy is applied so as to cause the protective coating on at least one of the sheets to become plastic in the preselected binding region.

17. An apparatus for forming a bound document from a plurality of sheets, comprising:
an imaging section configured to generate images on sheets of media;
a coating section configured to apply a protective coating to an imaged sheet of media;
a holding device configured to receive and hold a plurality of sheets of media; and
a binding device configured to apply a binding energy to a portion of the protective coating on at least one of a plurality of sheets of media in the holding device and thereby bind the sheets in the holding device to one another.

18. The apparatus of claim 17, and further comprising:
a processor;
a sheet binding program configured to be executed by the processor to control the binding device.

19. The apparatus of claim 17, and wherein the sheet binding device comprises:
a heating element near the holding device, the heating element movable between a first position in which the heating element is separated from the sheets of media and a second position in which the heating element contacts a sheet of media; and
a press coupled to the heating element, the press operative for each sheet output to the holding device to press the heating element against a preselected binding region of the sheet.

20. The apparatus of claim 19, and wherein:
the sheets of media are each defined by a first edge;
the binding device further comprises an anvil operably moveable from a first position in which the anvil is separated from the sheets of media and a second position in which the anvil is urged against the sheets of media proximate the first edge of the sheets of media; and
when the heating element is in the second position, it contacts a sheet of media along the first edge of the sheets of media.

21. A method of creating a pamphlet, comprising:
providing a sheet of media having a protective coating applied to a least a portion thereof;
folding the sheet of media to define first and second portions of a pamphlet, and wherein at least a portion of the protective coating applied to one portion of the pamphlet contacts the other portion of the pamphlet to define a binding region; and
applying a binding energy to the binding region to thereby bind the portions of the pamphlet into a sealed pamphlet.

22. The method of claim 21, and wherein:
the sheet of media is defined by a first side, a top edge, a bottom edge, and two opposite side edges, the side edges being essentially perpendicular to the top and bottom edges;
the protective coating is applied over the first side;
the sheet is folded along a fold line essentially parallel to the top edge; and
the binding energy is applied along at least one of the side edges or the top edge.

23. A method of creating a pamphlet, comprising:
providing a sheet of media defining a top edge, a first side and a second side, the first side having a protective coating applied thereto;
forming first and second folds in the sheet along fold lines essentially parallel to the top edge to produce a tri-fold pamphlet defined by substantially opposite, parallel side edges and an outward surface, and wherein the outward surface comprises the second side of the sheet; and
applying a binding energy to a binding region to thereby bind the portions of the pamphlet into a sealed pamphlet, the binding region comprising at least one of the side edges or the top edge of the pamphlet.

24. The method of claim 23, and wherein the binding region comprises the side edges and the top edge of the pamphlet.
